(19) United States
(12) Patent Application Publication
(10) Pub. No.: US 2011/0303369 A1
(43) Pub. Date: Dec. 15, 2011

(54) AWNING

(75) Inventors: Heinz-Georg FEHN, Schoppingen (DE); Peter RICHERT, Emsdetten (DE); Günter SCHÖTTLER, Emsdetten (DE)

(73) Assignee: SCHMITZ-WERKE GMBH + CO.KG, Emsdetten (DE)

(21) Appl. No.: 13/155,661

(22) Filed: Jun. 8, 2011

(30) Foreign Application Priority Data
Jun. 9, 2010 (DE) 10 2010 029 881.9

(51) Int. Cl. H04R 3/02; E04F 10/06

(52) U.S. Cl. 160/66

(57) ABSTRACT

An awning includes a base part, which can be attached to a building part, a fabric shaft, which can be rotatably driven thereon by means of a motor, an awning fabric, which can be retracted and extended and wound onto the fabric shaft and unwound therefrom, and a noise influencing system, which has a controller and at least one sound actuator activated thereby and coupled to an awning component, the at least one sound actuator producing a counter-sound pattern adapted to the sound pattern during the retraction and/or extension of the awning for influencing the noise, in particular noise and vibration damping.

### CROSS-REFERENCES TO RELATED APPLICATIONS

This application claims the priority of German Patent Application, Serial No. 10 2010 029 881.6, filed Jun. 9, 2010, pursuant to 35 U.S.C. 119(a)-(d), the content of which is incorporated herein by reference in its entirety as if fully set forth herein.

### FIELD OF THE INVENTION

The invention relates to an awning with a base part, which can be attached to a building part, a fabric shaft, which can be rotatably driven thereon by means of a motor, and an awning fabric, which can be retracted and extended and can be wound onto the fabric shaft and unwound therefrom. The base part should be taken to mean, in this case, any component, with the aid of which the awning, for example an articulated arm awning, winter garden awning or window awning, can be fastened to a building part, such as an external wall, a winter garden or a window reveal. Typically, base parts of this type are, owing to the type of construction, awning housings, fastening brackets, holding frames or the like.

### BACKGROUND OF THE INVENTION

The operating noises are a problem, in particular during automatic operation of awning systems with intelligent controllers. Awnings, which are equipped with sun, wind and/or rain sensors, extend and retract at different times depending on the personal adjustment of the control parameters. The awnings may be automatically extended here, for example, upon the first rays of sun. The noise produced from the mechanical drive is relayed via the building and the air. Precisely this noise is often felt to be extremely annoying by residents of the building, when it destroys their peace or even interrupts their sleep.

Hitherto, attempts were made by the most varied providers of awnings and awning drives to minimise these noises with mechanical means by way of passive noise reduction. None of these attempts, for example by means of mechanical decoupling or insulation, led to the desired aim, as the reduction in the body sound of the entire system proved to be inadequate overall.

One problem that emerges here is that good acoustic insulation of the motor leads to equally good heat insulation. The cooling behaviour, which is substantially slowed down, of the motor causes longer rest phases in terms of time between the retraction and extension of the awnings, which are controlled by the temperature monitoring. The transmission of vibrations (sound input) from the awning into the building proves to be a further particular problem. On the one hand, an awning has to be connected rigidly and force-fitted to the carrying part of a building for static reasons, but, on the other hand, should not transmit any oscillations. These problems generally require a compromise solution.

Disturbing noises may also be produced by undesired vibrations in a technical system, the primary problem in this connection not being the development of noise, but the possible damage or even destruction of system components owing to these undesired vibrations.

### SUMMARY OF THE INVENTION

Proceeding from the problems outlined of the prior art, the invention is based on an object of improving an awning in such a way that it can be retracted and extended as quietly and free of vibrations as possible.

According to the invention this object is achieved by a noise influencing system, which has a controller and at least one noise actuator, which is activated thereby and coupled to an awning component. This sound actuator produces a counter-sound pattern adapted to the sound pattern when the awning is retracted and/or extended to influence the noise and in particular to damp noise and vibration.

The invention, in this case, utilises the concept of active noise compensation basically already developed in 1933 by the German researcher Paul Lueg, in which sound waves being emitted by a sound source are detected by a microphone and sound suppression or even extinguishing of sound can take place by superimposition with acoustic signals in phase opposition thereto.

The physical background of an active sound suppression of this type will be briefly described below for the sake of completeness.

Sound waves can be shown as a function of location x and time t. Two sound waves s₁(x; t) and s₂(x; t) can be additively superimposed at a point x₀. This superimposition is called interference of waves at point x₀. At this point, a sinusoidal oscillation with the frequency f and the phase φ can be determined. Therefore, the following equations apply at point x₀

s₁(x₀; t)=a₁ sin(2Πf₁t+φ₁)

s₂(x₀; t)=a₂ sin(2Πf₂t+φ₂)

The simplest case of superimposition of two signals which are identical with respect to frequency and amplitude is now observed, of which only one signal is phase-displaced. The following therefore applies:
f₁=f₂=f
a₁=a₂=a
φ₁=0 and φ₂=φ

The following is produced for this observation for the superimposition of the two oscillations at the point x₀:

s(x₀; t)=s₁(x₀; t)+s₂(x₀; t)=a{sin(2Πf t)+sin(2Πf t+φ)}

The following equation is produced by transformation for the total oscillation:

s(x₀; t)=2a cos(φ/2) sin(2Πf t+φ/2)

If the amplitude of this oscillation is observed, it is striking that this becomes zero at precisely φ=180°, as can be seen from FIG. 1. This point is called destructive interference, as the two signals precisely cancel each other there. The region in which the signal becomes quieter in comparison to the individual signals is located between 120° and 240°. The amount of the total oscillation is smaller there than the amount of the individual oscillations.

A method and a corresponding device for active extinguishing of noise or vibrations is also described, for example, in WO 93/21688 A1. Here, the noise caused by a combustion engine is superimposed by an extinguishing noise signal, the residual noise signal formed therefrom being recorded by a microphone and being collected in a processor by means of a fast Fourier transformation and further processed in order to change the extinguishing signal in such a way that the residual sound signal becomes as small as possible. In this case, this document shows conventional mathematical procedures to determine the extinguishing signal.

According to preferred developments of the invention the sound actuator can act on the awning component with a predetermined counter-sound pattern, which was determined by a single measurement of the sound pattern, in particular when starting up the awning, and is correspondingly stored in the controller. This means low outlay in terms of apparatus, but the problem exists here that when there is a change in the sound pattern produced by the awning during retraction and extension, the counter-sound pattern is no longer adapted thereto for optimal noise damping.

To avoid this problem, a more complex embodiment of the invention provides that the sound influencing system has at least one microphone connected to the controller to currently detect, in each case, the sound pattern of the awning during retraction and/or extension. The controller then determines from the currently detected sound pattern the necessary counter-sound pattern to act on the awning component provided with the sound actuator. To this extent, changes to the sound pattern produced by the awning, for example because of wear, aging or environmental influences, are therefore also permanently included in the damping.

The counter-sound pattern to be produced by the sound actuator is preferably determined by the controller in real time, so an optimal noise suppression can be continuously achieved.

A further preferred embodiment of the awning according to the invention relates to the sound suppression already basically described above by destructive interference between the sound pattern produced from the awning and the applied counter-sound pattern.

A preferred configuration of a sound actuator provides the use of a contact loudspeaker for this. The number and positioning of contact loudspeakers of this type has to be adapted to the respective type of awning. Thus, the sound actuators may be coupled to the fabric shaft motor, the fabric shaft, a drop out profile, a support tube, awning housing, awning housing covers or a bracket part for the awning. One or more microphones for the active noise suppression of the system may also be positioned at corresponding locations.

In a particularly preferred configuration, the noise influencing system can not only be used for noise suppression, but also to achieve a desired audio pattern when retracting and/or extending the awning. Thus, the counter-sound pattern may not only have audio fractions, which are used to extinguish the noises produced by the awning, but also audio fractions which then produce by means of the awning, for example a melody or other noises positively interpreted by the user (bird twittering, sports car engine sound, water flowing noises).

Further features, details and advantages of the invention emerge from the following description of embodiments with the aid of the accompanying drawings.

### BRIEF DESCRIPTION OF THE DRAWINGS

FIG. 1 shows a graph of the amplitude of a superimposed oscillation as a function of the phase displacement between the individual signals,

FIGS. 2 and 3 show frequency analyses of the extension and retraction noise of an awning,

FIG. 4 shows a block diagram for a noise influencing system of an awning,

FIG. 5 shows a front view of an awning in a partially opened state,

FIGS. 6 and 7 show enlarged detailed views of the details A and B according to FIG. 5, and

FIG. 8 shows a partially broken away part view of an awning in a second embodiment.

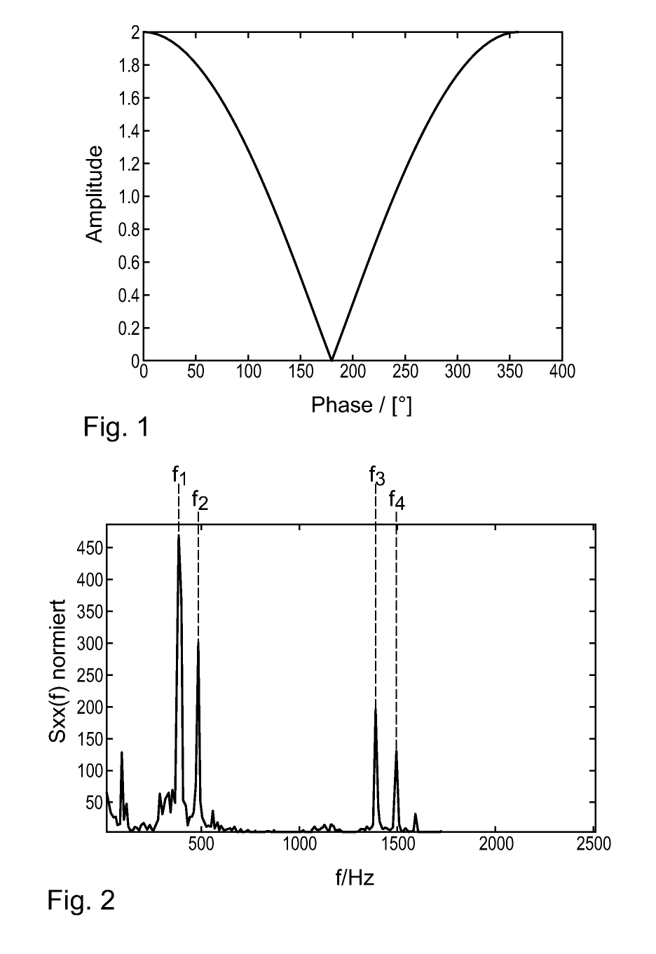

### DESCRIPTION OF THE PREFERRED EMBODIMENTS

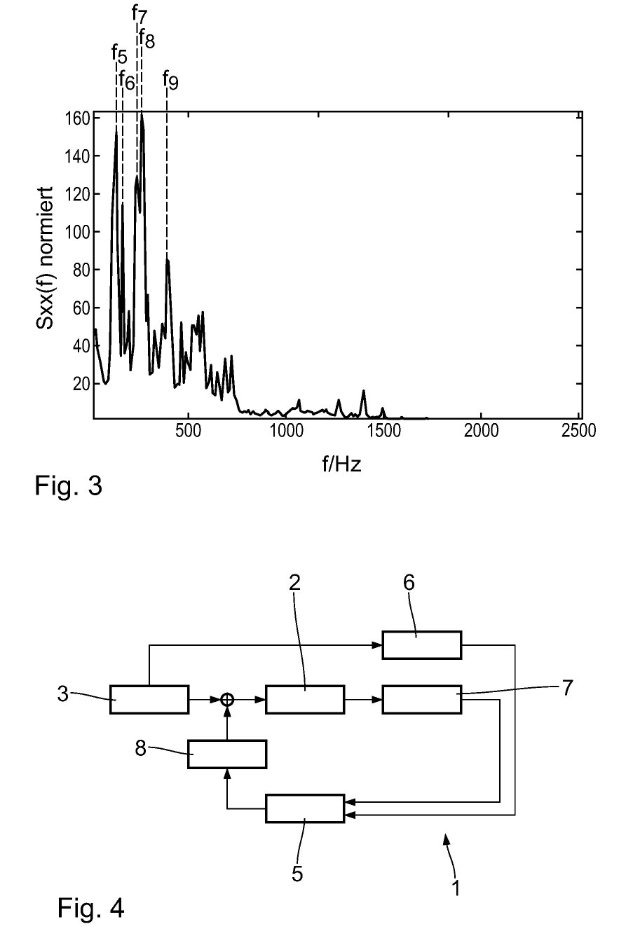

Before the actual noise influencing system according to the invention is dealt with, the noises occurring during the extension and retraction of an awning should be briefly characterised by way of example. Thus, in order to obtain a first impression of the objective sound level, basic measurements can be carried out, which substantially detect and analyse the emitted noise of an awning. With a microphone virtually linear up to about 12 kHz, the emitted acoustic signal can be recorded during the extension and retraction of an awning and subjected to a frequency analysis. The associated spectra according to FIGS. 2 and 3 show which frequencies are particularly clearly present in the signals and shape the audio pattern.

In addition, the sound level can be recorded using a level measuring device at a one metre distance from the awning. This measurement shows that the sound level of the extension process at about 61 dB(A) is slightly less than the measured retraction level at about 65 dB(A). Therefore the extension process is slightly quieter than the retraction process. This can be explained by the increased loading of the awning motor produced during the retraction process owing to the now additional weight of the extended awning.

It can be seen in FIGS. 2 and 3 that the extension and retraction process significantly differs with respect to the signals. While during the extension process, the frequencies f₁=387 Hz, f₂=484 Hz, f₃=1389 Hz and f₄=1497 Hz come to the fore particularly clearly, during retraction, the frequencies f₅=129 Hz, f₆=161 Hz, f₇=236 Hz, f₈=258 Hz and f₉=398 Hz are dominant.

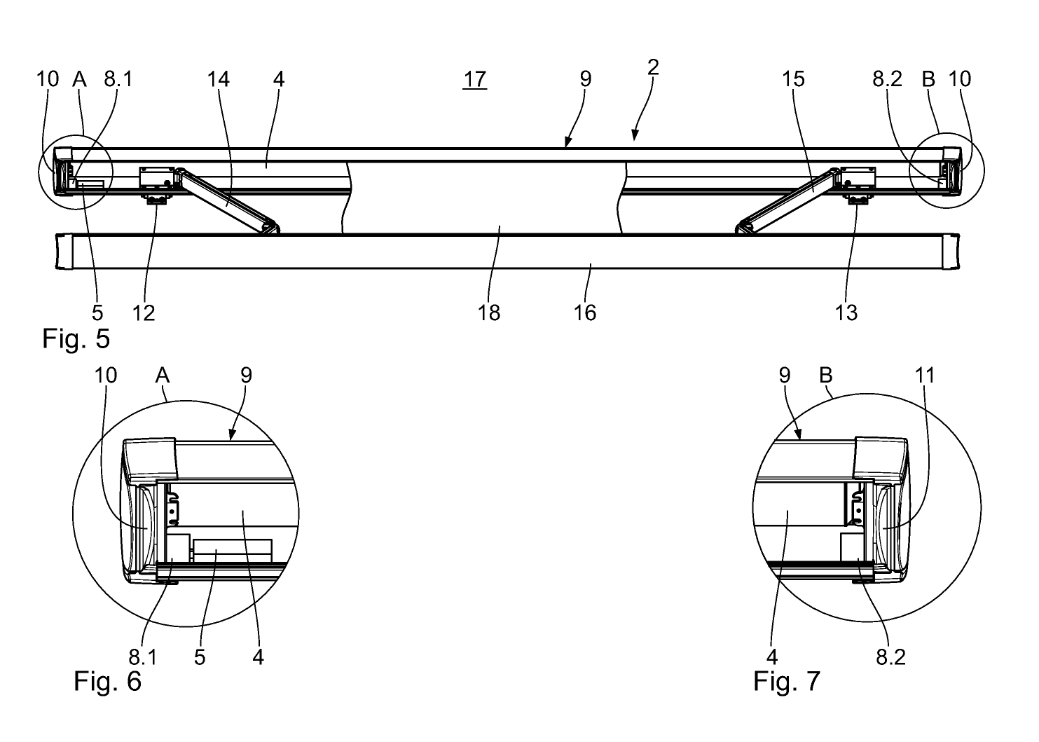

With the aid of FIG. 4, the basic structure of a noise influencing system 1 for an awning 2 and its motor 3 to drive the fabric shaft (4) can be described (FIGS. 5 to 7). Thus a microprocessor-based controller 5 is provided, which is coupled on the input side to two microphones 6, 7. One microphone 6 in this case records the sound pattern produced by the motor 3. The second microphone 7 registers the total sound pattern of the awning.

The sound signal information of the microphones 6, 7 is processed by the controller 5 in accordance with conventional algorithms for frequency analysis to form a counter-sound pattern, with which a sound actuator 8, which is coupled on the output side to the controller 5, is activated. This sound actuator 8 is, for example, a contact loudspeaker, which is coupled to the motor as a noise disturbance source. The controller 5 calculates in the system design shown according to FIG. 4, in real time, the respective counter-sound pattern to be emitted in each case by the sound actuator 8 to the motor 3. In a simplified embodiment, the awning noise during retraction and extension can merely be measured once with a microphone 7 before or during the start up of the awning and a corresponding counter-noise pattern can then be calculated and stored by the controller 5.

The noise actuator and microphones may, moreover, not only be coupled to the fabric shaft motor 3, but—as shown in FIGS. 5 to 7—also coupled to an awning housing part. An awning housing 9, which is closed on both sides by housing covers 10, 11, is thus provided in the awning according to FIGS. 5 to 7. The housing 9 is fastened by the housing brackets 12, 13 to an external wall 17 of a building.

The articulated arm awning 2 shown has articulated arm pairs 14, 15, which are spring-loaded and articulated to the housing brackets 12, 13 and which carry, at their drop end (not shown) a drop out profile 16. The awning fabric 18 is only indicated centrally in FIG. 5 for the sake of clarity; it can be wound onto the fabric shaft 4 and is fastened by its drop-side end in the drop out profile 16. Moreover, the microphones cannot be seen in these figures.

As becomes clear, in particular from FIGS. 6 and 7, the controller 5, with which the two sound actuators 8.1, 8.2 are coupled, is inserted in the housing 9. Said sound actuators are seated on the inside of the two housing covers 10, 11 in direct contact therewith, so the counter-sound pattern produced by the sound actuators 8.1, 8.2 is transmitted by the housing covers 10, 11 to the housing 9, so an extinguishing or at least damping of the noise produced by the awning during retraction and extension can take place therewith.

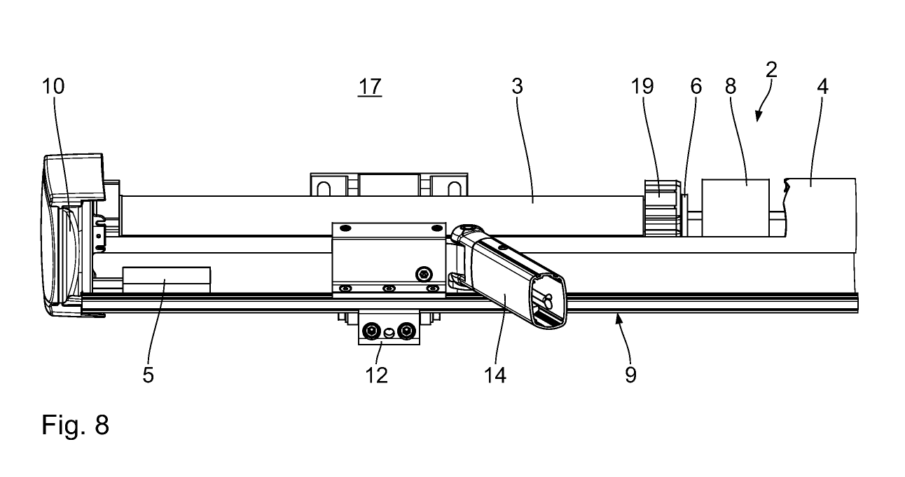

In the awning shown in FIG. 8, a drive configured as a tubular motor 3 can be seen in the region of the fabric shaft 4, which is shown broken away, said drive being mounted on the left-hand housing cover 10 of the housing 9 of the awning fastened to the wall bracket 12. A microphone 6, which is coupled, like the sound actuator 8 seated in the fabric shaft 4, to the controller 5, is seated within the fabric shaft 4 on the motor flange 19.

The sound pattern of the motor 3 measured by the microphone 6 within the fabric shaft 4 is in turn processed by the controller 5, so the controller 5 activates the sound actuator 8 in such a way that the latter produces a corresponding counter-sound pattern to act on the fabric shaft 4. Thus, the entire noise development of the awning can in turn be significantly reduced.

It is finally possible in the two embodiments of the awning for the controller 5 to not only produce a counter-sound pattern corresponding to the sound pattern, but also to superimpose a signal pattern, on the basis of which not only does a noise suppression take place in the region of the awning, but the latter also emits a desired audio pattern, such as a melody.

1-11. (canceled)

12. An awning comprising
a base part, which can be attached to a building part,
a fabric shaft, which can be rotatably driven thereon by means of a motor,
an awning fabric, which can be retracted and extended and wound onto the fabric shaft and unwound therefrom, and
a noise influencing system, which has a controller and at least one sound actuator activated thereby and coupled to an awning component, the at least one sound actuator producing a counter-sound pattern adapted to the sound pattern during at least one of the retraction and the extension of the awning for influencing the noise.

13. An awning according to claim 12, wherein the sound actuator acts on the awning component with a predetermined counter-sound pattern, which is determined by a single measurement of the sound pattern and is stored in the controller.

14. An awning according to claim 12, wherein the sound actuator acts on the awning component with a predetermined counter-sound pattern, which is determined by a single measurement of the sound pattern, when starting up the awning, and is stored in the controller.

15. An awning according to claim 12, wherein the noise influencing system has at least one microphone connected to the controller to detect the sound pattern of the awning during at least one of retraction and extension, the controller determining from the currently detected sound pattern the counter-sound pattern for acting on the awning component.

16. An awning according to claim 15, wherein the counter-sound pattern is determined in real time.

17. An awning according to claim 12, wherein the counter-sound pattern to influence the noise is in phase opposition to the sound pattern produced by the awning, so a noise suppression can be achieved by destructive interference between the sound pattern produced and the counter-sound pattern applied.

18. An awning according to claim 12, wherein the at least one sound actuator is configured as a contact loudspeaker.

19. An awning according to claim 12, wherein the at least one sound actuator is coupled to at least one of the fabric shaft motor, the fabric shaft, a drop out profile and one of the group of a support tube, an awning housing, awning housing part and awning bracket part representing the base part.

20. An awning according to claim 15, wherein the at least one microphone is coupled to at least one of the fabric shaft motor, the fabric shaft, a drop out profile and one of the group of a support tube, an awning housing, awning housing part and awning bracket part representing the base part.

21. An awning according to claim 12, wherein audio fractions are superimposed in the counter-sound pattern, with which a desired audio pattern can be achieved when one of retracting and extending the awning.

22. An awning according to claim 12, wherein the at least one sound actuator producing a counter-sound pattern adapted to the sound pattern during at least one of the retraction and the extension of the awning for noise and vibration damping.
